(19) United States
(12) Patent Application Publication
(10) Pub. No.: US 2007/0093951 A1
(43) Pub. Date: Apr. 26, 2007

(54) Method and device for emitting a warning

(75) Inventors: Carsten Schroeder, Renningen (DE); Peter Petschnigg, Stuttgart (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 10/569,069

(22) PCT Filed: Jul. 22, 2004
(86) PCT No.: PCT/DE04/01626

§ 371 Date: Nov. 8, 2006

(30) Foreign Application Priority Data
Sep. 16, 2003 (DE) 103 42 705.8

(51) Int. Cl. G06F 17/00

(52) U.S. Cl. 701/96; 701/93; 340/438; 340/463

(57) ABSTRACT

A method and a device for emitting a warning for a first motor vehicle equipped with an adaptive cruise control are provided, which device includes a unit for detecting if the first vehicle is standing still, as well as a unit for determining the distance and relative speed of a second vehicle, thereby making it possible to detect if a second vehicle located immediately ahead of the first vehicle is rolling backwards while the first vehicle is standing still. If the distance between the first and the second vehicle drops below a minimum distance, a warning is emitted to warn of the impending collision.

### FIELD OF THE INVENTION

The present invention relates to a method and a device for emitting a warning, in particular to a first motor vehicle equipped with an adaptive cruise control, means being provided for detecting that the first vehicle is standing still as well as means for ascertaining the distance and relative speed of a second vehicle, thereby making it possible to detect if a second vehicle located immediately ahead of the first vehicle is rolling backwards while the first vehicle is standing still. If the distance between the first and the second vehicle drops below a minimum distance, a warning is emitted to warn of the impending collision as a consequence of the second vehicle rolling backwards.

### BACKGROUND INFORMATION

The publication “Adaptive Cruise Control System, Aspects and Development Trends” by Winner, Witte, Uhler and Lichtenberg, which appeared at the SAE International Congress and Exposition in Detroit on Feb. 26-29, 1996, describes an adaptive cruise control that uses emitted radar waves to measure the distance and the relative speed of the vehicle traveling ahead and performs distance control with reference to a detected vehicle traveling ahead. If the radar sensor does not detect a vehicle traveling ahead, a speed control is implemented to a set speed specified by the driver. This adaptive cruise control can be activated within predetermined speed limits, for example, between 20 km/h and 180 km/h.

Taking advantage of an expanded sensor system and expanded vehicle functionality, future driver assist systems may be capable of automatically braking the vehicle to a stop as well as setting a vehicle braked to a stop back in motion. This will require additional cruise control functions.

An object of the present invention is to provide a method and a device that, in a stopped host vehicle equipped with adaptive cruise control, is able to detect if a vehicle traveling ahead is rolling backwards and warn the driver of the host vehicle and the driver of the vehicle traveling ahead.

### SUMMARY

In accordance with the present invention, it is advantageous that the adaptive cruise control detects the distance of the first vehicle from the second vehicle, their relative speed, their relative acceleration or the lateral displacement of both vehicles or a combination of the above. The adaptive cruise control may be designed, for example, as a radar sensor, laser sensor, ultrasonic sensor, or video sensor or as a combination of the above.

Furthermore, it is advantageous that the absolute speed of the first vehicle is ascertained using a speed sensor. Based on the ascertained true speed of the first vehicle and the relative speed, the relative acceleration and the distance of the first vehicle from the second vehicle, it is possible to determine both the absolute speed of the second vehicle as well as the direction of movement of the second vehicle.

Advantageously, the driver of the first vehicle is able to change the minimum distance, below which the warning is emitted. To that end, for example, driver-operable actuating elements are provided which may be used to set this minimum distance.

Furthermore, it is advantageous that the emitted warning is an acoustic and/or a visual warning.

Furthermore, it is advantageous that the warning is emitted to the driver of the first vehicle. Furthermore, it is advantageous that the warning is also emitted to the driver of the second vehicle and/or to the vehicle surroundings. For example, the acoustic warning may be a buzzer in the interior of the first vehicle which informs the driver of the first vehicle. It is also possible to activate the vehicle horn as an acoustic warning, via which it is also possible to inform the vehicle surroundings as well as the driver of the second vehicle traveling ahead. An indicator light or a display in a vehicle display may be provided as a visual warning via which the driver of the first vehicle is informed. It is furthermore possible to activate the front lights of the vehicle as a visual warning, in particular in the form of a headlamp flasher, via which light signals may be emitted to the second vehicle traveling ahead so that the driver of the second vehicle is visually informed in this manner.

It is furthermore advantageous that the means for detecting that the first vehicle is standing still is a speed sensor.

It is furthermore advantageous that the means for determining the distance and the relative speed of the second vehicle is an adaptive cruise control, via which it is possible to ascertain the distance of the first vehicle from the second vehicle, their relative speed, their relative acceleration or the lateral displacement of both vehicles in relation to one another or a combination of the above. To this end, it is possible to use radar sensors, laser sensors, ultrasonic sensors, video sensors or a combination of the sensor types described. Furthermore, it is also not mandatory to implement the method according to the present invention in the context of an adaptive cruise control; instead, it may also be provided as an independent function in the vehicle or as part of another system, for example, as a function of an ultrasonic- or radar-based parking assistance device.

It is furthermore advantageous that driver-operable setting means are provided, making it possible for the driver of the first vehicle to change the minimum distance so that it is possible for the driver to determine the minimum distance below which the warning is emitted.

Advantageously, the means for emitting the warning are an acoustic and/or a visual warning device.

It is furthermore advantageous that the warning device emits the warning to the driver of the first vehicle and/or the driver of the second vehicle and/or the vehicle surroundings.

An example implementation of the method according to the present invention may be in the form of a control element provided for a control unit of an adaptive cruise control of a motor vehicle. In this connection, a program is stored in the control element which is executable in a computer, in particular in a microprocessor or signal processor, and is suitable for implementing the method according to the present invention. In this case, the present invention is implemented by a program stored in the control element so that this control element provided with the program represents the present invention in the same manner as the method. An electric memory medium, for example, a read only memory, may be used as a control element for storing the program.

### BRIEF DESCRIPTION OF THE DRAWINGS

FIG. 1 shows a schematic block diagram of an example embodiment of the device according to the present invention.

FIG. 2 shows a flow chart of an example embodiment of the method according to the present invention.

### DETAILED DESCRIPTION

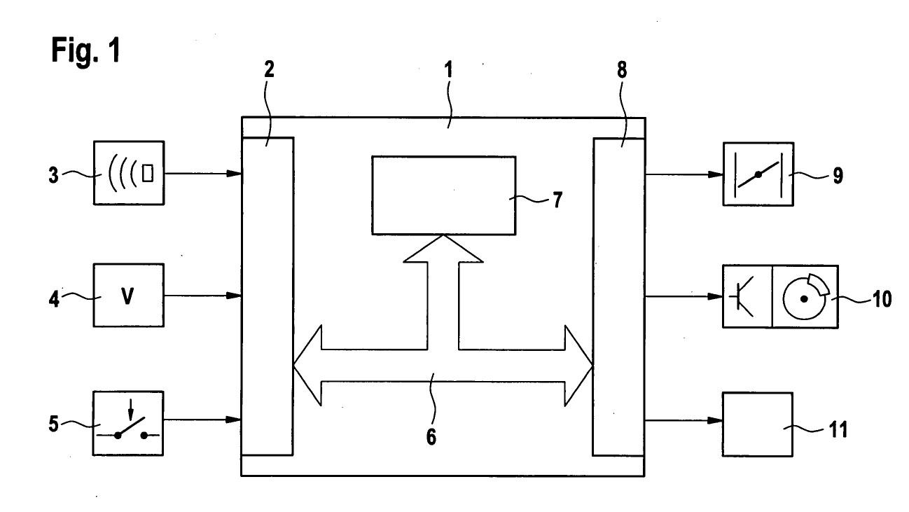

A cruise control 1 having an input circuit 2 is shown in FIG. 1. Input circuit 2 feeds input signals from other devices 3, 4, 5 to cruise control 1. Device 3 is, for example, a radar sensor which emits radar beams and receives and analyzes partial waves reflected from objects. Radar sensor 3 makes it possible to detect the presence of an object in the sensing range of radar sensor 3, the distance of the sensor from this object as well as the relative speed between the object and the vehicle. As an alternative, it is also possible to use a laser sensor, known also as a LIDAR sensor, an ultrasonic sensor, or a video camera including appropriate image analysis instead of a radar sensor. This radar sensor 3 (or a described alternative) feeds measuring data to input circuit 2, such as, for example, distance d of the object from the host vehicle, relative speed Vrel of the object in relation to the host vehicle, the azimuth angle under which the vehicle traveling ahead was detected, which makes it possible to calculate, for example, the lateral displacement of the vehicle traveling ahead. It is also possible to use a plurality of radar sensors instead of radar sensor 3, each of the radar sensors emitting its measuring signals to input circuit 2. It is also possible to use a plurality of different sensors, for example, radar sensors in combination with laser sensors, radar sensors in combination with a video camera, laser sensors in combination with a video camera or any other combination of the mentioned sensor types. Each sensor individually emits its measured values to input circuit 2 of cruise control 1 in order to incorporate them in the analysis.

Furthermore, a velocity signal V originating from a velocity detection device 4 is fed to input circuit 2 of cruise control 1. This velocity detection device 4 may be designed, for example, as a velocity sensor or it may use the velocity signal of an antilock function, which continuously measures the wheels speeds, or it may utilize an electronic vehicle dynamics control system for determining the absolute speed of the host vehicle. This velocity signal is fed to input circuit 2 of the cruise control.

A driver-operable control element 5 is also provided, which the driver of the vehicle may use to start, switch off and change the settings of the adaptive cruise control. For example, it is possible for the driver to set a time interval at which the host vehicle is to follow the vehicle traveling ahead or to specify a minimum distance dmin, below which a warning is to be emitted. These control signals are also fed to input circuit 2 of adaptive cruise control 1.

Input circuit 2 forwards the received signals to a calculation device 7 using a data exchange device 6 which may advantageously be designed as a bus system. Calculation device 7 may advantageously be designed as a microprocessor or signal processor and, as a function of the variables fed to cruise control 1, it calculates actuating signals which may be used to actuate the engine and brakes of the vehicle. In particular, the method according to the present invention may also be executed on calculation device 7, the method determining whether or not the conditions for emitting a warning are present.

The actuating signals and warning signals ascertained by calculation device 7 are fed via data exchange device 6 to an output circuit 8, which forwards the output signals of cruise control 1 to downstream processing devices 9, 10, 11. For example, it is provided to emit an acceleration request signal to a power-determining actuator 9 of an engine. If the cruise control determines that the regulated vehicle is to be accelerated, then this acceleration signal is emitted to a power-determining actuator 9 which may be designed, for example, as an electrically controllable throttle valve, a fuel quantity metering device of a common-rail injection system, a control rod of a fuel injection pump or comparable devices. If, in contrast, cruise control 1 determines that the host vehicle is to be decelerated, an actuating signal is emitted to deceleration devices 10 of the vehicle. Deceleration devices 10 may be designed, for example, as electrically actuable braking devices which generate or implement a braking force or a brake pressure from the electric deceleration request signal.

Output circuit 8 also emits a warning signal generated by calculation device 7 to a warning device 11. Warning device 11 may be, for example, an indicator light in the vehicle's instrument panel or a display in a programmable display of the vehicle's instrument panel that informs the driver that his/her own vehicle is standing still and the vehicle traveling ahead is rolling backwards, making it possible that the vehicle traveling ahead will collide with the host vehicle. As an alternative or in addition, warning device 11 may activate the vehicle horn and/or the headlamps of the vehicle. Activating the vehicle horn also makes it possible to inform the driver of the vehicle traveling ahead that his/her vehicle is rolling backwards and that a collision is possible. A headlamp flasher, i.e., alternatingly switching the vehicle's low bean or the headlamp on and off, makes it possible to inform the driver of the vehicle traveling ahead that his/her vehicle is rolling backwards and of the possible collision.

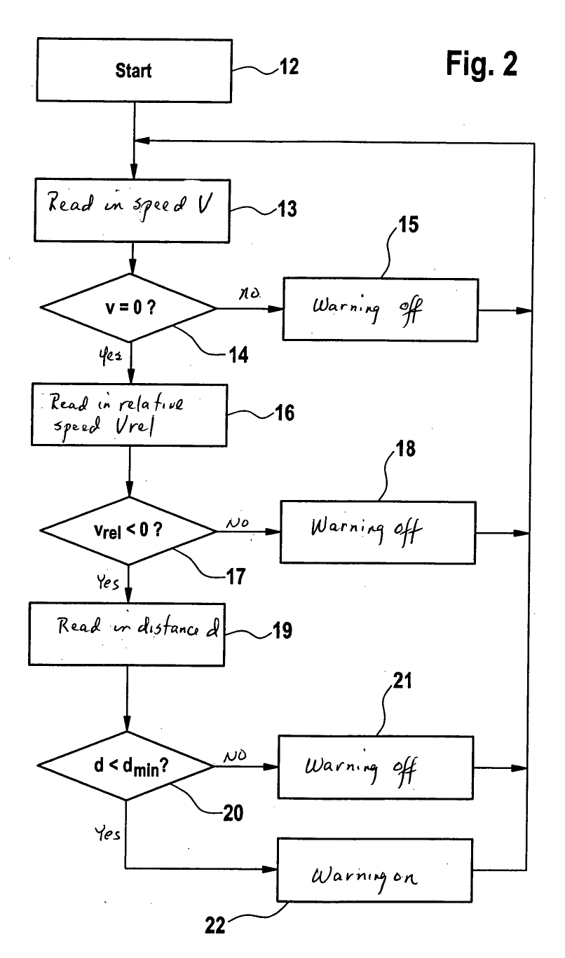

FIG. 2 shows a flow chart of an example embodiment of the method according to the present invention, which may be executed in calculation device 7 of adaptive cruise control 1. The method starts in block 12, which is triggered, for example, by the startup of cruise control 1 by driver-operable control element 5. It is also possible to start this method in block 12 by switching on the vehicle's ignition. After that, speed V is read in in block 13, the speed having been ascertained by velocity detection device 4 and fed to controller unit 1. In block 14, it is queried if speed V is equal to zero, i.e., if the host vehicle is standing still. If this is not the case, block 14 branches to “no” and the warning is switched off in block 15. If the warning has already been switched off earlier, block 15 has no effect. After that, the method returns to block 13 and speed V is read in once more.

If the query in block 14 shows that the vehicle's velocity V is equal to zero, i.e., the vehicle is standing still, the diagram branches to block 16 in which relative velocity Vrel is read in. Relative velocity Vrel is fed to controller 1 via environmental sensor 3, which is able to measure the distance and the relative speed of the vehicle traveling ahead. In the following step 17, it is queried if relative velocity Vrel is less than zero. If this is not the case, i.e., the vehicle traveling ahead has a relative speed equal to zero, is thus also standing still, or Vrel is greater than zero, i.e., the vehicle traveling ahead is moving forward, block 17 branches to “no” and switches the warning off in block 18 and branches back to block 13. If the warning has already been deactivated before block 18, block 18 has no effect.

If it is ascertained in block 17 that relative speed Vrel of the vehicle traveling ahead in relation to the host vehicle is negative, meaning that the vehicle traveling ahead is moving backwards, block 17 branches to “yes” and the method is continued in block 19. Distance d is read in in block 19. Distance d is ascertained using environmental sensor 3, which may be embodied, for example, as a radar sensor, and is sent to controller 1 and supplied for evaluation in calculation device 7.

In the following block 20, it is checked if measured distance d is less than minimum distance dmin, which may be set by the driver using control element 5. If block 20 shows that the present distance d between the first and the second vehicle is greater than or equal to minimum distance dmin, block 20 branches to “no” and switches off the warning in block 21. If the warning has already been deactivated, block 21 has no effect and branches again to block 13.

If block 20 shows that distance d from the first to the second vehicle is less than minimum distance dmin specified by the driver, block 20 branches to “yes” and a warning is activated in block 22. This warning may be, for example, an indicator light, a display, the vehicle horn or a headlamp flasher of the vehicle. After the warning is activated, the diagram branches to block 13 and is run through once again, the warning staying activated until one of the conditions according to block 14, 17 or 20 deactivates the warning in blocks 15, 18 or 21.

1-13. (canceled)

14. A method for generating a warning, comprising:
detecting, using a detection unit provided in a first vehicle equipped with an adaptive cruise control, whether the first vehicle is standing still; and
detecting whether a second vehicle located immediately ahead of the first vehicle is rolling backwards, if the first vehicle is determined to be standing still; and
emitting a warning if a distance between the first and the second vehicle drops below a predetermined minimum distance.

15. The method as recited in claim 1, wherein the adaptive cruise control ascertains at least one of: a) the distance between the first vehicle and the second vehicle; b) a relative speed between the first vehicle and the second vehicle; c) a relative acceleration between the first vehicle and the second vehicle; d) a lateral displacement between the first vehicle and the second vehicle.

16. The method as recited in claim 15, further comprising:
determining an absolute speed of the first vehicle using a speed sensor.

17. The method as recited in claim 15, wherein the predetermined minimum distance is selectively adjusted by the driver of the first vehicle.

18. The method as recited in claim 15, wherein the emitted warning includes at least one of an acoustic warning and a visual warning.

19. The method as recited in claim 15, wherein the warning is emitted to a driver of the first vehicle.

20. The method as recited in claim 15, wherein the warning is emitted to at least one of a driver of the second vehicle and a surrounding environment of the first vehicle.

21. A device for generating a warning, comprising:
a detection unit provided in a first vehicle equipped with an adaptive cruise control, wherein the detection unit determines whether the first vehicle is standing still; and
a detection unit provided in the first vehicle for detecting a relative distance and a relative speed between the first vehicle and a second vehicle located immediately ahead of the first vehicle, wherein the detection unit determines based on the relative distance and the relative speed whether the second vehicle is rolling backwards; and
a warning unit for emitting a warning if the relative distance between the first and the second vehicle drops below a predetermined minimum distance.

22. The device as recited in claim 21, wherein the detection unit that determines whether the first vehicle is standing still is a speed sensor.

23. The device as recited in claim 21, wherein the detection unit for detecting the relative distance and the relative speed is an adaptive cruise control unit, wherein the adaptive cruise control is configured to further ascertain at least one of: a) a relative acceleration between the first vehicle and the second vehicle; and b) a lateral displacement between the first vehicle and the second vehicle.

24. The device as recited in claim 21, further comprising:
an adjusting unit, wherein a driver of the first vehicle is able to selectively adjust the predetermined minimum distance.

25. The device as recited in claim 21, wherein the warning unit includes at least one of an acoustic warning device and a visual warning device.

26. The device as recited in claim 25, wherein the warning unit emits the warning to at least one of: a) a driver of the first vehicle; b) a driver of the second vehicle; and c) a surrounding environment of the first vehicle.
